(19) United States
(12) Patent Application Publication
(10) Pub. No.: US 2025/0381865 A1
(43) Pub. Date: Dec. 18, 2025

(54) INTERCHANGEABLE ELECTRIFIED-VEHICLE CHARGING/DISCHARGING CABLE

(71) Applicant: Toyota Motor North America, Inc., Plano, TX (US)

(72) Inventors: Norman Ning Lu, Ann Arbor, MI (US); Geoffrey David Gaither, Ann Arbor, MI (US)

(73) Assignees: Toyota Motor North America, Inc., Plano, TX (US); Toyota Jidosha Kabushiki Kaisha, Toyota-shi Aichi-ken (JP)

(21) Appl. No.: 18/743,507

(22) Filed: Jun. 14, 2024

(51) Int. Cl. B60L 53/18; B60L 53/16

(52) U.S. Cl. CPC B60L 53/18; B60L 53/16

(57) ABSTRACT

Embodiments of an interchangeable electrified-vehicle charging/discharging cable are disclosed herein. In one embodiment, a cable for an electrified vehicle comprises a vehicle connector that electrically connects with an inlet of an electrified vehicle. The cable also includes an interchange connector that electrically connects with an assembly (e.g., a charger, device, premises, power grid, etc.) detachably. The cable also includes conductors that electrically connect the vehicle connector with the interchange connector. The conductors include a proximity pilot conductor that electrically connects a charging and discharging control system of the electrified vehicle with a proximity circuit of the assembly. The proximity circuit includes a predetermined standardized resistance value that identifies the assembly to the charging and discharging control system of the electrified vehicle.

### TECHNICAL FIELD

The subject matter described herein relates in general to electrified vehicles and, more specifically, to an interchangeable electrified-vehicle charging/discharging cable.

### BACKGROUND

As electrified vehicles grow in popularity and market share, their capabilities will expand. Electrified vehicles will require charging, but they will also be able to discharge power in various new ways. This will lead to a proliferation of accessory products that, when damaged or lost, will need to be replaced.

One difficulty is that conventional accessory products are designed for a single purpose. For example, a conventional portable charging accessory has a fixed (non-detachable) charging cable, a control box, and a grid plug connector. A conventional wall charger has a wall-mounted control box and a fixed (non-detachable) charging cable. A consumer desiring both a portable charging accessory and a wall charger is thus forced to purchase duplicates of many components, particularly the charging cable. Analogous redundancies occur with the purchase of conventional accessories for discharging applications.

### SUMMARY

Embodiments of an interchangeable electrified-vehicle charging/discharging cable are presented herein. In one embodiment, a cable for an electrified vehicle comprises a vehicle connector that electrically connects with an inlet of an electrified vehicle. The cable also includes an interchange connector that electrically connects with an assembly detachably. The cable also includes conductors that electrically connect the vehicle connector with the interchange connector. The conductors include a proximity pilot conductor that electrically connects a charging and discharging control system of the electrified vehicle with a proximity circuit of the assembly. The proximity circuit includes a predetermined standardized resistance value that identifies the assembly to the charging and discharging control system.

Another embodiment is an electrical cable that comprises a vehicle connector that electrically connects a first end of the electrical cable with an electrified vehicle. The electrical cable also includes an interchange connector that electrically connects a second end of the electrical cable with an assembly detachably. The electrical cable also includes conductors between the first and second ends that electrically connect the vehicle connector with the interchange connector. The conductors include a proximity pilot conductor that electrically connects a charging and discharging control system of the electrified vehicle with a proximity circuit of the assembly. The proximity circuit includes a predetermined resistance value that identifies the assembly to the charging and discharging control system.

Another embodiment is an article of manufacture that comprises a vehicle connector that electrically connects with an electrified vehicle. The article of manufacture also includes an interchange connector that electrically connects with an assembly detachably. The article of manufacture also includes conductors that electrically connect the vehicle connector with the interchange connector. The conductors include a proximity pilot conductor that electrically connects a charging and discharging control system of the electrified vehicle with a proximity circuit of the assembly. The proximity circuit includes a predetermined resistance value that identifies the assembly to the charging and discharging control system.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is a diagram of an electrical cable that connects with an electrified vehicle and an assembly, in accordance with an illustrative embodiment of the invention.

FIG. 2 illustrates options for an interchange connector of the electrical cable diagrammed in FIG. 1, in accordance with an illustrative embodiment of the invention.

FIG. 3A is a diagram of two types of electrified-vehicle charging assemblies with which the electrical cable diagrammed in FIG. 1 can be connected, in accordance with illustrative embodiments of the invention.

FIG. 3B is a diagram of four types of electrified-vehicle discharging assemblies with which the electrical cable diagrammed in FIG. 1 can be connected, in accordance with illustrative embodiments of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

The various embodiments of an interchangeable electrified-vehicle charging/discharging cable described herein overcome the shortcomings of conventional electrified-vehicle accessory products, in particular the lack of interchangeability of the cable among different products. In embodiments, an interchangeable electrified-vehicle charging/discharging cable supports a suite of vehicle-to-anything (V2X) products, including chargers (both portable and wall-mounted), vehicle-to-load (V2L) adapters, vehicle-to-home (V2H) discharging units, and vehicle-to-grid (V2G) discharging units. This suite is an improvement over existing products because it features a common electrified-vehicle charging/discharging cable (a “V2X cable”) that is interchangeable among all associated products in the suite. This interchangeability of the cable reduces the number of parts a consumer needs to use each product and facilitates simple and cost-effective replacement parts.

It should be noted that, in conventional accessory products, the vehicle-connector portion of the non-detachable (non-interchangeable) charging/discharging cable includes a proximity circuit whose characteristic standardized resistance value enables the charging and discharging control system of an electrified vehicle to identify what type of accessory product is connected with the electrified vehicle. This identifying resistance value in the vehicle connector of the cable itself renders the cable useful for only one specific application-the one pertaining to the accessory product with which the cable is non-detachably (permanently) connected. The embodiments of an interchangeable electrified-vehicle charging/discharging cable described herein overcome that limitation, as described in further detail below.

Herein, an “electrified vehicle” refers to a battery electric vehicle (BEV) or a plug-in hybrid electric vehicle (PHEV), including any variation of a PHEV, such as a gasoline, diesel, or hydrogen-fuel-cell PHEV. In general, the various embodiments of an interchangeable electrified-vehicle charging/discharging cable described herein apply to any vehicle that includes a charge port.

Herein, an “assembly” refers broadly to a system, platform, or device with which an electrified vehicle is connected via an interchangeable charging/discharging cable. That is, the cable can be connected with and subsequently detached from both an electrified vehicle and the applicable assembly. Examples of assemblies include, without limitation, those mentioned above: (1) chargers (both portable and wall-mounted); (2) V2L adapters that permit an electrified vehicle to power a variety of devices such as computers, cellular phones, household appliances, power tools, camping gear, arc welders, etc.; (3) V2H discharging units that enable an electrified vehicle to supply power to a premises (e.g., a residence or business); and (4) V2G discharging units that enable an electrified vehicle to supply power to a power grid (e.g., a consumer sells power from an electrified vehicle back to the electric utility).

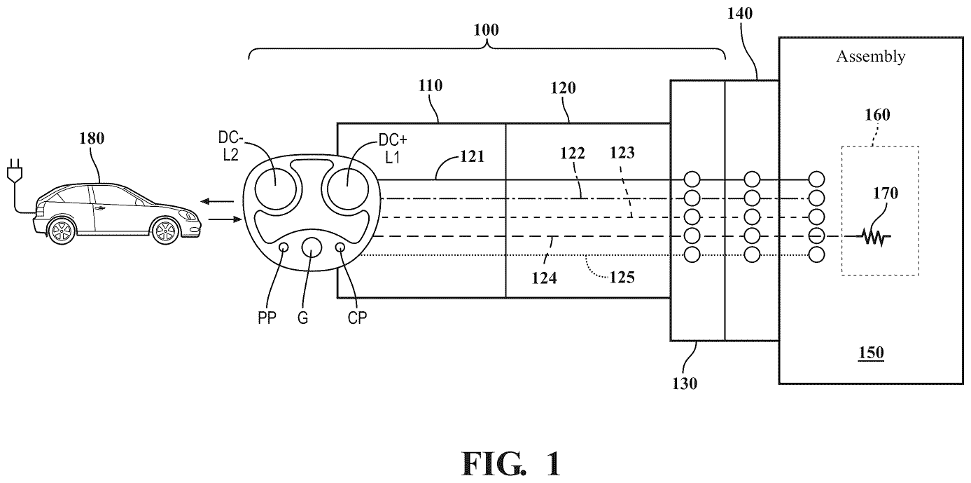

FIG. 1 is a diagram of an electrical cable 100 (hereinafter simply a “cable 100”) that connects with an electrified vehicle 180 and an assembly 150, in accordance with an illustrative embodiment of the invention. As shown in FIG. 1, cable 100 is made up of a vehicle connector 110 that physically and electrically connects with an inlet (not shown in FIG. 1) of an electrified vehicle 180, a set of conductors 120 (e.g., copper wires), and an interchange connector 130 that physically and electrically connects with a mating connector 140 of the assembly 150. The conductors 120 are electrically connected with both the vehicle connector 110 and the interchange connector 130, as indicated in FIG. 1. An important feature of the cable 100 is its ability to connect detachably with the mating connector 140 of a given assembly 150. That is, the interchange connector 130 renders the cable 100 interchangeable with a variety of different kinds of assemblies 150 because of its physical and electrical compatibility with the mating connector 140 of any given assembly 150 in the suite of products mentioned above.

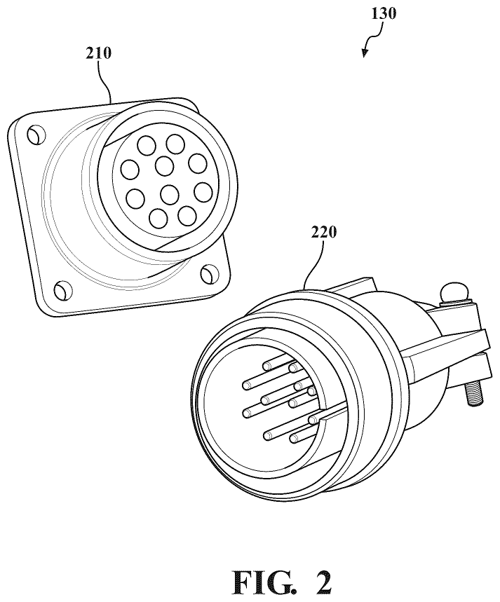

FIG. 2 illustrates options for an interchange connector 130 of the electrical cable 100 diagrammed in FIG. 1, in accordance with an illustrative embodiment of the invention. FIG. 2 shows, as non-limiting examples, female and male versions of a particular kind of interchange connector 130. More specifically, FIG. 2 illustrates a circular female multi-contact (10-contact) connector 210 and a circular male multi-pin (10-pin) connector 220 manufactured by Amphenol Corporation. These are merely illustrative examples, however. In other embodiments, cable 100 includes a different kind of interchange connector 130.

Referring again to FIG. 1, the vehicle connector 110 can vary, depending on the embodiment. Two examples include, without limitation, a SAE J1772 connector and a SAE J3400 connector (used by Tesla, Inc.). In some embodiments, the vehicle connector 110 is a SAE J1772 connector that includes an electrical and physical switch identified in the standard as “S3,” which prevents operation of the charging/discharging system of an electrified vehicle 180 unless the connector is fully physically and electrically connected with the inlet of the electrified vehicle 180. That is, the S3 switch protects against partial engagement of the vehicle connector 110 with the inlet of the electrified vehicle 180.

Conductors 120 include L1/DC+121, L2/DC−122, ground (GND) 123, proximity pilot 124, and control pilot 125. Of particular importance to various embodiments of the cable 100 described herein is the proximity pilot conductor 124, which is discussed further below.

As shown in FIG. 1, an important innovation in the embodiments disclosed herein is the inclusion of a proximity circuit 160 with its characteristic standardized resistance value 170 in the assembly 150 instead of in the vehicle connector 110 of the cable. This design change removes from the cable the application-specific resistance value 170 that identifies the assembly 150 to the charging and discharging control system of the electrified vehicle 180, allowing the cable 100 to be interchangeable among a variety of different types of assemblies 150, as discussed above. The proximity pilot conductor 124 of cable 100 electrically connects the charging and discharging control system of the electrified vehicle 180 with the proximity circuit 160 that is part of the assembly 150. This enables the charging and discharging control system of the electrified vehicle 180 to detect the predetermined standardized resistance value 170 that identifies the assembly 150 to the charging and discharging control system. That is, the charging and discharging control system can determine, based on the detected resistance value 170, what type of assembly 150 is connected with the electrified vehicle 180 via cable 100. The resistance value 170 of a given assembly 150 can be in accordance with a standard such as the Society of Automotive Engineers (SAE) J2847/5.

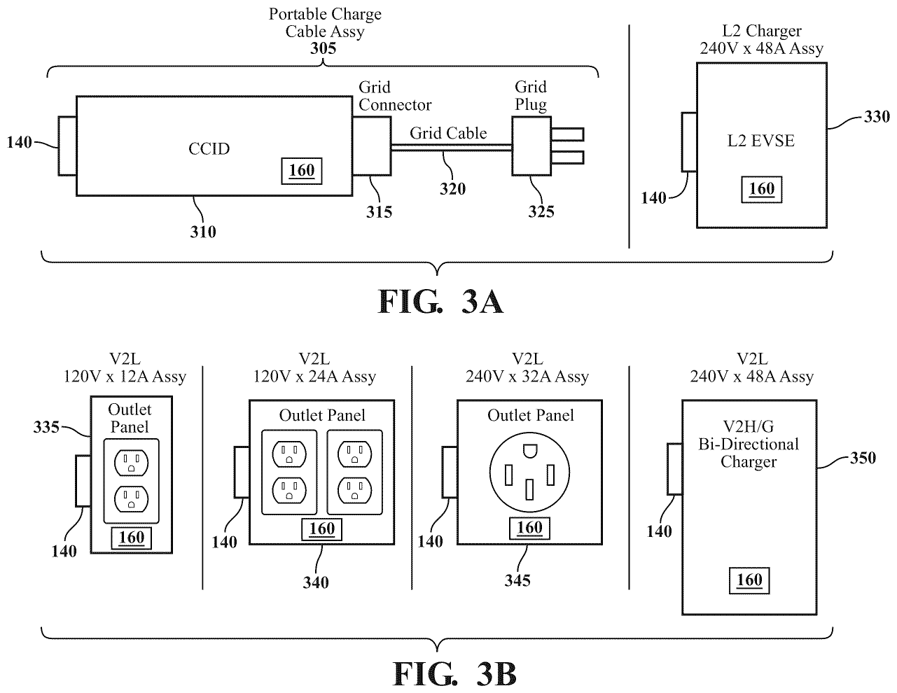

FIG. 3A is a diagram of two types of electrified-vehicle charging assemblies with which the electrical cable 100 diagrammed in FIG. 1 can be connected, in accordance with illustrative embodiments of the invention. The two charging assemblies depicted in FIG. 3A both fall under the general category of assemblies 150, as discussed above. First (on the left), FIG. 3A diagrams a portable charge cable assembly 305 that includes a mating connector 140, a Charge Current Interrupting Device (CCID) 310, a grid connector 315, a grid cable 320, and a grid plug 325. Importantly, portable charge cable assembly 305 also includes a proximity circuit 160 with a predetermined resistance value 170 (not shown in FIG. 3A), as discussed above. Second (on the right), FIG. 3A diagrams a L2 charger 240-V×48-A assembly 330 that includes, among other components, a mating connector 140 and a proximity circuit 160 that includes a predetermined resistance value 170 (not shown in FIG. 3A). The L2 charger 240-V×48-A assembly 330 can also be referred to as Electric Vehicle Supply Equipment (EVSE) (e.g., a wall-mounted charging system). The cable 100 described above can connect with either type of charging assembly, portable charge cable assembly 305 or L2 charger 240-V×48-A assembly 330, via the mating connector 140 in the respective charging assemblies.

FIG. 3B is a diagram of four types of electrified-vehicle discharging assemblies with which the electrical cable diagrammed in FIG. 1 can be connected, in accordance with illustrative embodiments of the invention. All four types of discharging assemblies illustrated in FIG. 3B fall under the general category of assemblies 150, as discussed above. FIG. 3B illustrates a V2L 120-V×12-A assembly 335, a V2L 120-V×24-A assembly 340, a V2L 240-V×32-A assembly 345, and a V2H/G charger 240-V×48-A assembly 350. Each of these assemblies 150 includes a mating connector 140 for connection with a cable 100 and a proximity circuit 160 that includes a predetermined resistance value 170 (not shown in FIG. 3B). The discharging assemblies 150 shown in FIG. 3B are merely illustrative examples. The cable 100 can be connected with a variety of other kinds of assemblies 150 to which an electrified vehicle 180 supplies power via a cable 100.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-3B, but the embodiments are not limited to the illustrated structure or application.

The components described above can be realized in hardware or a combination of hardware and software and can be realized in a centralized fashion in one processing system or in a distributed fashion where different elements are spread across several interconnected processing systems. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” As used herein refers to and encompasses any and all possible combinations of one or more of the associated listed items. As an example, the phrase “at least one of A, B, and C” includes A only, B only, C only, or any combination thereof (e.g. AB, AC, BC or ABC).

As used herein, “cause” or “causing” means to make, command, instruct, and/or enable an event or action to occur or at least be in a state where such event or action may occur, either in a direct or indirect manner.

Aspects herein can be embodied in other forms without departing from the spirit or essential attributes thereof. Accordingly, reference should be made to the following claims rather than to the foregoing specification, as indicating the scope hereof.

What is claimed is:

1. A cable for an electrified vehicle, the cable comprising:
a vehicle connector that electrically connects with an inlet of the electrified vehicle;
an interchange connector that electrically connects with an assembly detachably; and
conductors that electrically connect the vehicle connector with the interchange connector, wherein the conductors include a proximity pilot conductor that electrically connects a charging and discharging control system of the electrified vehicle with a proximity circuit of the assembly, the proximity circuit including a predetermined standardized resistance value that identifies the assembly to the charging and discharging control system.

2. The cable of claim 1, wherein the assembly is one of a portable electrified-vehicle charging system and a wall-mounted electrified-vehicle charging system.

3. The cable of claim 1, wherein the assembly is a premises to which the electrified vehicle supplies power via the cable.

4. The cable of claim 1, wherein the assembly is a device to which the electrified vehicle supplies power via the cable.

5. The cable of claim 1, wherein the assembly is a power grid to which the electrified vehicle supplies power via the cable.

6. The cable of claim 1, wherein the interchange connector is physically and electrically compatible with a plurality of different kinds of assemblies.

7. The cable of claim 1, wherein the interchange connector is one of a circular male multi-pin connector and a circular female multi-contact connector.

8. The cable of claim 1, wherein the vehicle connector is a Society of Automotive Engineers (SAE) J1772 connector that includes a S3 switch.

9. An electrical cable, comprising:
a vehicle connector that electrically connects a first end of the electrical cable with an electrified vehicle;
an interchange connector that electrically connects a second end of the electrical cable with an assembly detachably; and
conductors between the first and second ends that electrically connect the vehicle connector with the interchange connector, wherein the conductors include a proximity pilot conductor that electrically connects a charging and discharging control system of the electrified vehicle with a proximity circuit of the assembly, the proximity circuit including a predetermined resistance value that identifies the assembly to the charging and discharging control system.

10. The electrical cable of claim 9, wherein the assembly is one of a portable electrified-vehicle charging system and a wall-mounted electrified-vehicle charging system.

11. The electrical cable of claim 9, wherein the assembly is a premises to which the electrified vehicle supplies power via the electrical cable.

12. The electrical cable of claim 9, wherein the assembly is a device to which the electrified vehicle supplies power via the electrical cable.

13. The electrical cable of claim 9, wherein the assembly is a power grid to which the electrified vehicle supplies power via the electrical cable.

14. The electrical cable of claim 9, wherein the interchange connector is physically and electrically compatible with a plurality of different kinds of assemblies.

15. An article of manufacture, comprising:
a vehicle connector that electrically connects with an electrified vehicle;
an interchange connector that electrically connects with an assembly detachably; and
conductors that electrically connect the vehicle connector with the interchange connector, wherein the conductors include a proximity pilot conductor that electrically connects a charging and discharging control system of the electrified vehicle with a proximity circuit of the assembly, the proximity circuit including a predetermined resistance value that identifies the assembly to the charging and discharging control system.

16. The article of manufacture of claim 15, wherein the assembly is one of a portable electrified-vehicle charging system and a wall-mounted electrified-vehicle charging system.

17. The article of manufacture of claim 15, wherein the assembly is a premises to which the electrified vehicle supplies power via the article of manufacture.

18. The article of manufacture of claim 15, wherein the assembly is a device to which the electrified vehicle supplies power via the article of manufacture.

19. The article of manufacture of claim 15, wherein the assembly is a power grid to which the electrified vehicle supplies power via the article of manufacture.

20. The article of manufacture of claim 15, wherein the interchange connector is physically and electrically compatible with a plurality of different kinds of assemblies.
